(19) United States
(12) Patent Application Publication
(10) Pub. No.: US 2004/0174269 A1
(43) Pub. Date: Sep. 9, 2004

(54) System and method for tracking personnel at a site

(76) Inventors: Russell L. Miller, Traverse City, MI (US); Michael A. Whelan, Traverse City, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/383,077

(22) Filed: Mar. 6, 2003

(51) Int. Cl. G08B 5/22

(52) U.S. Cl. 340/825.49; 340/539.13

(57) ABSTRACT

A system for tracking personnel at a site includes a collection board and a plurality of input devices. The collection board includes a plurality of discrete zones, which each correspond to a user configurable location. At least a portion of one of the input devices is associated with each of the discrete zones. The input devices are configured to receive input information from a personnel identification (ID) tag assigned to a specific individual when the personnel ID tag is located within an input range of one of the input devices.

### BACKGROUND OF THE INVENTION

The present invention is generally directed to a system for tracking personnel at a site and more specifically to a system that includes a collection board and a plurality of input devices with at least a portion of the input devices being associated with each of a number of discrete zones of the collection board.

When emergency services organizations respond to a site or incident, it is generally desirable to track the responding personnel, units and companies. At the most basic level, there is a need to identify that these entities are at a site or on site. In general, these entities are assigned to one or more specific locations or assignments. In this manner, personnel, units and companies are accounted for at an incident or site. Historically, personnel, units and companies have been tracked using paper and pencil. That is, people and units have been tracked by marking them down on a piece of paper, whiteboard, etc. Often, the piece of paper may include a preprinted template that allows a person in charge of site accountability to write in personnel names and units under a standard heading, such as Division 1, Rescue Group, etc. The person in charge of site accountability can then visually inspect the piece of paper or other marking media to determine the status of deployed personnel and units.

The collection board system is generally thought to be an improvement to the manual system. The collection board system utilizes a board, which is used to assign specific personnel to a site or incident. Such a system has typically been implemented by assigning personnel identification (ID) tags to each firefighter that may be responding to an incident. In general, when the firefighters report to their stationhouse, they attach their ID tag on a collector ring associated with their unit. The collector ring is typically carried in the fire truck or other apparatus with which that unit is associated. The collector ring typically includes a unit tag that identifies the unit. In this manner, each of the reporting personnel are assigned to a given unit.

Typically, during large incidents, the collector rings or assemblies are removed from the apparatus and posted on a collection board (i.e., an incident management board), such that a command officer can visually see the units that have responded to a given incident. The command officer may write in a location or assignment on the collection board next to the unit collector assemblies to indicate the unit's location or assignment. In this manner, the command officer could then visually inspect the personnel ID tags attached to the collector assemblies to verify the personnel assigned to an individual unit. Some large metropolitan emergency response organizations simplify the above-described technique by only tracking units. That is, they assume that preassigned personnel will always be attached to a unit. In this case, the command officer may post unit tags, emblems or icons on a board to show the unit's attendance and assignments without having specific personnel ID tags present.

U.S. Pat. Nos. 5,596,652 and 5,793,882 describe automated systems and methods for accounting for personnel at a site. In general, these systems utilize a computer to log responding personnel and units that are at the site. Machine readable media, such as magnetic strips, barcodes or radio frequency identification (RFID) tags have been utilized to automatically identify a person or unit. In general, these media have been queried, i.e., scanned, read, etc., to capture information such that this information can be stored and organized in the computer. A user of the computer can then associate the personnel and units with specific assignments or locations. From the stored information, reports can be generated by the system to summarize assignments. In general, these reports may be simple textual lists or may be more graphical in nature and show the unit icons at a mock scene. However, such systems may require more user intervention and input to track all of the personnel and units that may be present at a specific site than prior systems, such as the above-described collection board system. Furthermore, because many emergency response organizations presently use the collection board system, there is some reluctance to change personnel reporting protocols.

What is needed is an improved collection board that automates the tracking of the personnel at a site, and, thus, provides the reporting benefits of an automated system without requiring any changes to personnel reporting protocols.

### SUMMARY OF THE INVENTION

An embodiment of the present invention is directed to a system for tracking personnel at a site that includes a collection board and a plurality of input devices. The collection board includes a plurality of discrete zones, with each of the discrete zones corresponding to a user configurable location or assignment. At least a portion of one of the input devices is associated with each of the discrete zones. Each of the input devices are configured to receive input information from a personnel identification (ID) tag assigned to a specific individual when the personnel ID tag is located within an input range of one of the input devices.

In one embodiment, the input devices are radio frequency identification (RFID) readers. In other embodiments, the RFID readers include an antenna that is attached or integrated within the collection board.

These and other features, advantages and objects of the present invention will be further understood and appreciated by those skilled in the art by reference to the following specification, claims and appended drawings.

### BRIEF DESCRIPTION OF THE DRAWINGS

In the drawings:

FIG. 1 is a front view of an exemplary collection board, including four discrete zones; and

FIG. 2 is an exemplary electrical block diagram of a computer system, which is coupled to and receives input from a plurality of input devices, which may be attached to or integrated within the collection board of FIG. 1.

### DETAILED DESCRIPTION OF PREFERRED EMBODIMENTS

An embodiment of the present invention is directed to a collection board that includes a plurality of discrete zones that correspond to user configurable locations and/or assignments, each of which zones include at least a portion of an input device, which are configured to receive input information from a personnel identification (ID) tag, assigned to a specific individual, when the personnel ID tag is located within an input range of the input device.

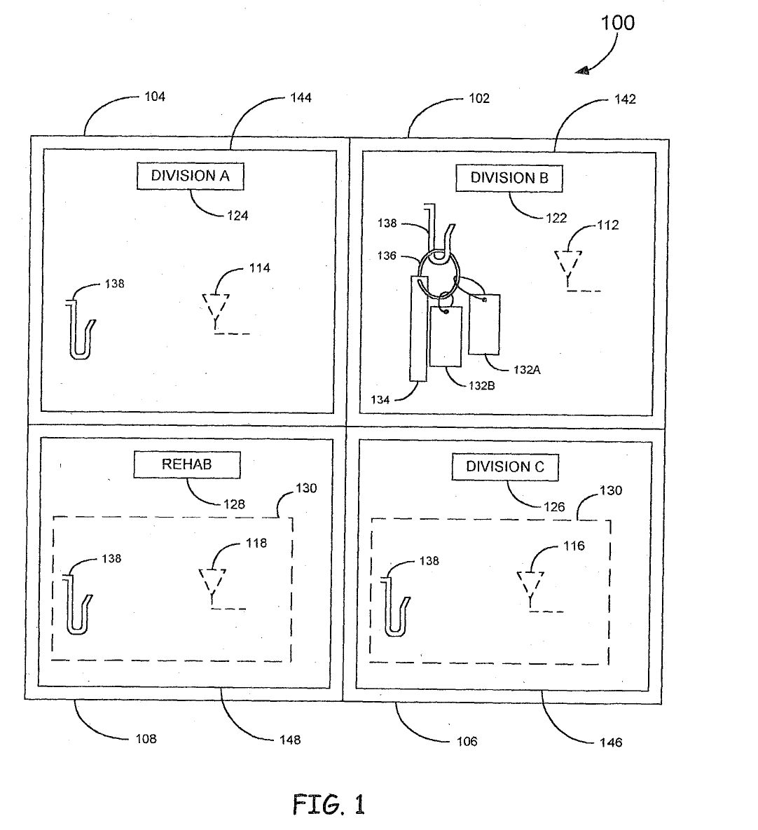

As is shown in FIG. 1, an exemplary collection board 100 is divided into four discrete zones 102, 104, 106 and 108. It should be appreciated that collection boards with more or less than four discrete zones may be implemented according to the present invention. Further, the zones of the collection boards may be linearly configured. Each of the discrete zones 102-108 may include a shield 142, 144, 146 and 148, respectively. The shields 142-148 serve to shield an antenna associated with each of the discrete zones 102-108. As shown in FIG. 1, the discrete zone 102 has an associated antenna 112 and the discrete zone 104 has an associated antenna 114. Similarly, the discrete zone 106 has an associated antenna 116 and the discrete zone 108 has an associated antenna 118. The antennas 112-118 may be attached to a back and/or front side of the collection board 100 in its respective zone or may be integrated within the collection board 100 within its respective zone. Each of the zones 102-108 includes one or more fasteners 138, e.g., spring clips and/or hook and loop type fasteners marketed under the trademark Velcro®), for attaching a tag, e.g., unit tag 134, which has attached personnel ID tags, e.g., tags 132A and 132B, to the collection board 100. For example, the personnel ID tags 132A and 132B may be attached to a ring 136, which is also attached to the unit tag 134. It should be appreciated that the fasteners 138 are located within a zone such that RFID transponders located within the tags 132A, 132B and 134 may communicate with an RFID reader through the respective antennas 112-118. Alternatively, the tags 132A and 132B may be configured to communicate with the tag 134, which is configured to communicate with an RFID reader through the antennas 112-118.

Thus, the collection board 100 includes a number of reading zones 102-108 that correspond to user configurable assigned locations or functions. These discrete zones or reading zones are created by attaching multiple RFID readers and/or a reader antenna to the collection board 100 such that RFID transponders associated with the tags 132A, 132B and 134 within proximity of one of the antennas is recognized and associated with a specific reader. It should be appreciated that the boundaries of the reading zones of a given antenna are a function of the power and frequency of the transmission. If need be, shielding 142-148 can be incorporated within the collection board 100 to shield the antennas 112-118 such that an RFID transponder of one tag located in one zone does not communicate with an RFID reader associated with another zone.

According to one embodiment, the approximate boundaries of the reading zone of an antenna include a visual indicator 130 that designates the reading zone for an associated one of the input devices. The reading zones may be color coded and/or may take various geometric shapes, such as a rectangle, circle or square. It should also be appreciated that, if desired, multiple collection boards can be utilized for very large deployments with numerous assignments, locations or responders. The collection board 100 can be configured for specific locations or assignments by attaching a location/assignment RFID tag 122, 124, 126 and 128 in proximity to the reading zone using various fasteners, such as a spring clip, adhesive or hook and loop type fasteners marketed under the trademark Velcro®. In this manner, a specific reading zone becomes associated with a specific location/assignment.

It should be appreciated that a user of the system may have multiple pre-made location/assignment RFID tags, including a set for how they normally deploy at an incident. For example, a particular user may always deploy using a division structure. Alternatively, special tags or special or extraordinary incident tags may be implemented. For example, a tag may track by function versus division or by function and division. It should be appreciated that this gives a user significant flexibility in how to deploy and track at any given site. Alternatively, a collection board can be configured with an RFID host computer system using software and, for example, the discrete zone 104 may be assigned to “Division A.” It should be appreciated that personnel responding to a given scene will have a personnel ID tag that includes an RFID transponder integrated into the tag. As with a typical tag/collection board system, personnel attach their ID tags to a collector assembly in an apparatus, such as a fire engine. A collector assembly may also have an RFID transponder integrated into its ID tag. It should be appreciated that when the incident escalates, these collector assemblies can be attached to a collection board within a reading zone of a desired location/assignment. In this manner, the unit tag and attached personnel tags become associated with the reading zone and, as such, with the associated location/assignment.

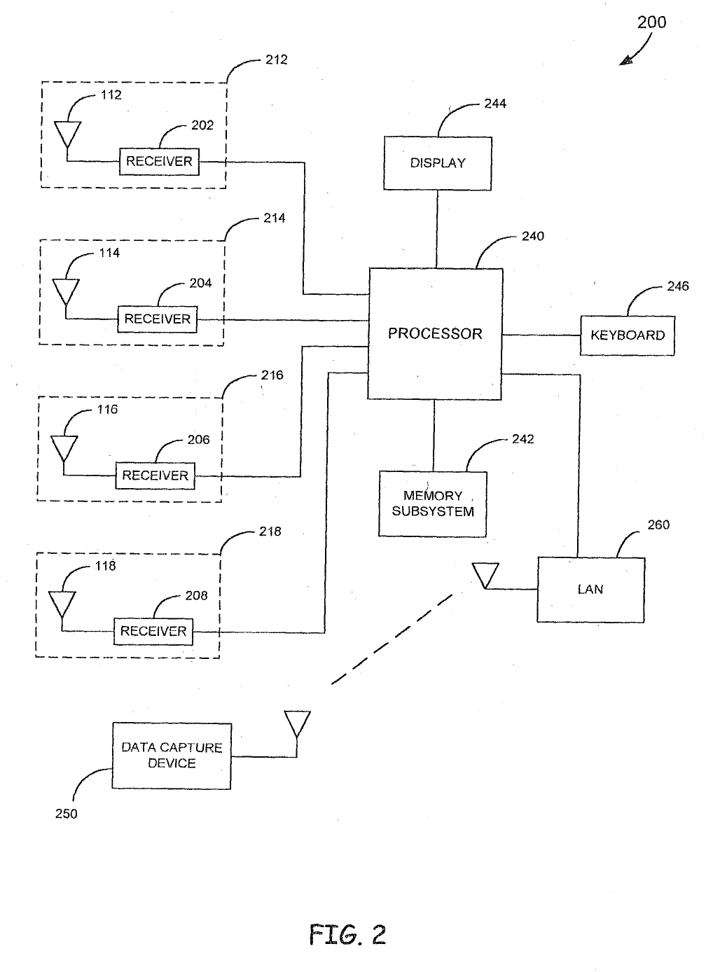

With reference to FIG. 2, the electrical circuitry of a collection board system 200 is further depicted. As previously discussed, the antennas 112-118 are attached to or integrated with the collection board 100 within appropriate zones. As is shown in FIG. 2, the antenna 112 is coupled to an input of receiver 202, whose output is coupled to a first input of a processor 240. The antenna 114 is coupled to an input of receiver 204, whose output is coupled to a second input of the processor 240. The antenna 116 is coupled to an input of receiver 206, whose output is coupled to a third input of the processor 240. Similarly, the antenna 118 is coupled to an input of receiver 208, whose output is coupled to a fourth input of the processor 240. The processor 240 is programmed to periodically or continuously address each of the receivers 202-208 to determine what RFID codes are being received. Alternatively, the processor 240 may be serially coupled to the outputs of the receivers 202-208 or a single receiver could be used that is coupled to antennas 112-118 in a multiplexed configuration.

As shown in FIG. 2, the processor 240 is also coupled to a memory subsystem 242, a display 244 and a keyboard 246. The processor 240 implements a routine, which associates transponder codes from personnel ID tags and unit tags within an appropriate location/assignment. The processor 240 is also programmed to display information on the display 244 regarding the assignments. It should be appreciated that the display 244 may be integrated with the collection board 100. For example, the display 244 may mount to a portion of the collection board 100. In this manner, the processor 240 runs a routine, which associates unit tags and attached personnel ID tags with a given reading zone and, as such, with a given location/assignment. Association between the personnel ID tags and the unit tags can be controlled by a time-based algorithm such that personnel do not become associated with a different unit tag that was attached earlier or later to the board. For example, the system 200 may associate the tags of all new reads occurring over a two second time frame. In this manner, personnel become assigned to a unit and the unit becomes assigned to a location/assignment. The processor 240 periodically reads the RFID network to identify changes in the status of personnel, units and assignments. Thus, reports can be generated to display the status of all personnel and units, including graphical reports, using icons to display deployment and command structure. As previously described, the collection board 100 can have an attached or integrated monitor/screen/CRT or other viewing device to display the deployment/command structure in virtual real-time.

According to another embodiment, an RFID capable data capture device 250 (see FIG. 2), such as a Palm Pilot™ or a personal digital assistant (PDA), is utilized to capture data on units and personnel at a remote staging area or entry point. In this embodiment, the data capture device 250 is programmed as a location/assignment device or, alternatively, a location/assignment RFID transponder may be attached to the device to associate the device with that location/assignment. The data capture device 250 communicates with the host processor 240 via radio frequency communications, such as an IEEE 802.11 wireless local area network (LAN) 260, to provide the status of the remote reading zone.

It should be appreciated that the receiver associated with each antenna may also be integrated within a specific zone of the collection board 100. However, to maintain portability of the collection board, it may be desirable to only attach/integrate the antenna into the collection board and provide plug-in cables to connect each of the antennas to one or more readers/receivers. In this manner, the collection board can remain compact and foldable. Further, such an automated board can advantageously also be used as a simple manual collection board if automation is not required.

It should also be appreciated that the present invention can be utilized for tracking various personnel in a variety of fields. For example, the collection board can be utilized to track victims/casualties of an incident, construction workers, utility workers, miners, migrant workers, forestry workers, fishermen, etc. The present invention can also be utilized to track workers at a factory, building or plant setting, students or other people and their assignments or locations, irrespective of the location and/or the function of the personnel. The present invention may be advantageously implemented in emergency evacuation applications with a zone corresponding to an individual's department, floor, building, etc.

Accordingly, a collection board system has been described herein that essentially overlays a manual tag/collection board system with an RFID network. Thus, with virtually no changes in standard operating procedures, a user can automate the identification of all responding personnel and units and where they are located and/or assigned. Using pre-made location/assignment RFID tags, a user can easily configure the collection board to track a standard or unique set of locations/assignments. Thus, resources can be properly accounted for with minimum user input or intervention.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

What is claimed is:

1. A system for tracking personnel at a site, comprising:
a collection board including a plurality of discrete zones, wherein each of the discrete zones corresponds to a user configurable location; and
a plurality of input devices, wherein at least a portion of one of the input devices is associated with each of the discrete zones, and wherein each of the input devices are configured to receive input information from a personnel identification (ID) tag assigned to a specific individual when the personnel ID tag is located within an input range of one of the input devices.

2. The system of claim 1, wherein the input devices are radio frequency identification (RFID) readers.

3. The system of claim 1, wherein the input devices are radio frequency identification (RFID) readers and each of the RFID readers includes an antenna that is attached to the collection board.

4. The system of claim 1, wherein the input devices are radio frequency identification (RFID) readers and each of the RFID readers includes an antenna that is integrated within the collection board.

5. The system of claim 1, wherein each of the discrete zones includes a shield that isolates each of the input devices.

6. The system of claim 1, wherein each of the discrete zones includes a visual indicator that designates a reading zone for an associated one of the input devices.

7. The system of claim 6, wherein the visual indicator includes a color-coded geometric shape.

8. The system of claim 7, wherein the geometric shape is one of a square and a circle.

9. The system of claim 1, wherein each of the discrete zones includes a fastener located approximate a reading zone for receiving a unit tag that includes a radio frequency identification (RFID) transponder.

10. The system of claim 9, wherein the fastener is one of a spring clip and a hook and loop type fastener.

11. The system of claim 1, wherein the personnel ID tags are each attached to a unit tag, and wherein the personnel ID tags and the unit tag each include an integrated radio frequency identification (RFID) transponder.

12. A system for tracking personnel at a site, comprising:
a collection board including a plurality of discrete zones, wherein each of the discrete zones corresponds to a user configurable location;
a plurality of input devices, wherein at least a portion of one of the input devices is associated with each of the discrete zones, and wherein each of the input devices are configured to receive input information from a personnel identification (ID) tag assigned to a specific individual when the personnel ID tag is located within an input range of one of the input devices;
a processor coupled to the plurality of input devices, wherein the processor is programmed to periodically poll the input devices to update personnel assignments; and
a display coupled to the processor, wherein the updated personnel assignments are displayed on the display.

13. The system of claim 12, wherein the input devices are radio frequency identification (RFID) readers.

14. The system of claim 12, wherein the input devices are radio frequency identification (RFID) readers and each of the RFID readers includes an antenna that is attached to the collection board.

15. The system of claim 12, wherein the input devices are radio frequency identification (RFID) readers and each of the RFID readers includes an antenna that is integrated within the collection board.

16. The system of claim 12, wherein each of the discrete zones includes a shield that isolates each of the input devices.

17. The system of claim 12, wherein each of the discrete zones includes a visual indicator that designates a reading zone for an associated one of the input devices.

18. The system of claim 17, wherein the visual indicator includes a color-coded geometric shape.

19. The system of claim 18, wherein the geometric shape is one of a square and a circle.

20. The system of claim 12, wherein each of the discrete zones includes a fastener located approximate a reading zone for receiving a unit tag that includes a radio frequency identification (RFID) transponder.

21. The system of claim 20, wherein the fastener is one of a spring clip and a hook and loop type fastener.

22. The system of claim 12, wherein the personnel ID tags are each attached to a unit tag, and wherein the personnel ID tags and the unit tag each include an integrated radio frequency identification (RFID) transponder.

23. A system for tracking personnel at a site, comprising:
a collection board including a plurality of discrete zones, wherein each of the discrete zones corresponds to a user configurable location; and
a plurality of radio frequency identification (RFID) readers, wherein at least a portion of one of the RFID readers is associated with each of the discrete zones, and wherein each of the RFID readers are configured to receive input information from a personnel identification (ID) tag including an RFID transponder when the personnel ID tag is located within an input range of one of the RFID readers, where the personnel ID tag is assigned to a specific individual.

24. The system of claim 23, wherein each of the RFID readers include an antenna that is attached to the collection board.

25. The system of claim 24, wherein each of the RFID readers include an antenna that is integrated within the collection board.

26. The system of claim 24, wherein a time-based algorithm is utilized to automatically associate the personnel ID tag to a specific unit tag within one of the discrete zones.
